(19) United States
(12) Patent Application Publication
(10) Pub. No.: US 2026/0310741 A1
(43) Pub. Date: Oct. 8, 2026

(54) AUTOMATED WEBSITE PROTOTYPING

(71) Applicant: PAYPAL, INC., San Jose, CA (US)

(72) Inventors: Chandra Sekhar Nallam, Lathrop, CA (US); Jayanth Mohana Krishna, Santa Clara, CA (US); Sarat Babu Annapaneni, Edison, NJ (US); Taehee Roy Han, Evanston, IL (US); Michael Ryan Kelly, Hudson, IL (US); Laxmikant Sharma, San Ramon, CA (US); Bryan Ellis, Austin, TX (US); Reginald Spencer Farrell, Austin, TX (US); Shivani Bayala Banerjee, San Jose, CA (US); Mudita Tiwari, Cupertino, CA (US); Asish Mohanty, Santa Clara, CA (US)

(21) Appl. No.: 19/569,688

(22) Filed: Mar. 17, 2026

Related U.S. Application Data
(60) Provisional application No. 63/782,306, filed on Apr. 2, 2025.

(51) Int. Cl. G06F 16/957

(52) U.S. Cl. CPC G06F 16/9577

(57) ABSTRACT

A method includes obtaining a website template corresponding to a first user input from a user device, providing the website template and an interactive form to the user device for display on the user device, receiving a second user input via the interactive form, providing a prompt to a generative model for generating website content, receiving the website content generated by the generative model in response to the prompt, replacing the content placeholder of the code segment with the website content to form a modified website template, and providing the modified website template to the user device for display on the user device.

### TECHNICAL FIELD

The present disclosure relates to websites and, more particularly, to automated website generation for demonstrating features integrated with the website.

### BACKGROUND

Prototyping is a process of creating a mock or sample version of a website that showcases one or more specific features. Developers may use prototyping to test, demonstrate, and/or refine the feature in a controlled environment before implementing it in a live production setting.

### BRIEF DESCRIPTION OF THE DRAWINGS

Certain features of the subject technology are set forth in the appended claims. However, for the purpose of explanation, several embodiments of the subject technology are set forth in the following figures, where like reference numerals refer to the same or similar features in the various figures.

FIG. 1 is a block diagram of an example website generation system, in accordance with one or more embodiments.

FIG. 2 is a process diagram of an example process performed by the system of FIG. 1, in accordance with one or more embodiments.

FIG. 3 is a block diagram of an example website template with text content replacement, in accordance with one or more embodiments.

FIG. 4 is a block diagram of the example website template of FIG. 3 with image content replacement, in accordance with one or more embodiments.

FIG. 5 is a block diagram of the example website template of FIG. 3, in accordance with one or more embodiments.

FIG. 6 is an example user interface for selecting a website template, in accordance with one or more embodiments.

FIG. 7 is an example user interface for displaying a website template, in accordance with one or more embodiments.

FIG. 8 is an example user interface for displaying a first populated website template, in accordance with one or more embodiments.

FIG. 9 is an example user interface for displaying a second populated website template, in accordance with one or more embodiments.

FIG. 10 is a flow diagram of an example automated website generation process performed by a prototyping server, in accordance with one or more embodiments.

FIG. 11 is a block diagram of an example computing system, in accordance with one or more embodiments.

### DETAILED DESCRIPTION

An approach to demonstrating new features (e.g., visual components, interactive functionalities, or third-party integrations) within the context of a web-based environment is by prototyping. However, traditional approaches to prototyping often require constructing a complete website from the ground up, which can be both time-intensive and inefficient, particularly when the prototype is tailored to specific audiences or use cases.

To address these challenges, the systems and methods described herein leverage a collection of reusable website templates that enable rapid and flexible prototyping. When a developer specifies a feature that they wish to demonstrate, the system selects one or more appropriate templates that support and/or highlight the selected feature. Developers can further customize the generated website by providing contextual parameters, such as the expected use, thematic focus, or visual style. These input parameters guide the system in shaping the overall structure and presentation of the prototype.

The system may utilize generative artificial intelligence (AI) models capable of producing relevant synthetic content. This AI-generated content may be used to replace placeholders within the website templates, resulting in a functional and tailored prototype without requiring the developer to manually author every piece of textual or visual content. Because the content is modular and reusable, it can be distributed across multiple templates within the same website, enhancing consistency and reducing redundancy.

Once the website prototype is complete, the system offers multiple options for user interaction. Users can inspect code snippets directly in the user interface, allowing for quick validation or iterative modification of the showcased feature. Additionally or alternatively, the website files can be downloaded for local hosting or further development. This approach streamlines the prototyping process, accelerates development timelines, and supports a more interactive and customized feature demonstration experience.

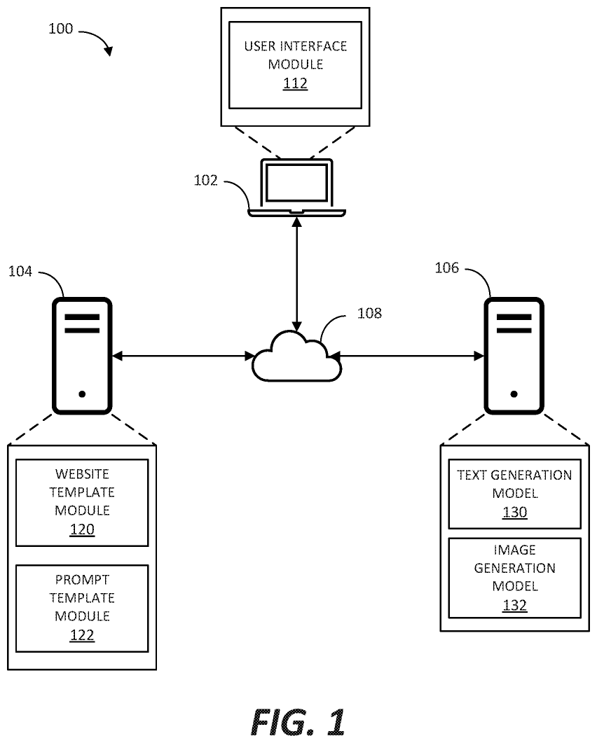

Referring now to the drawings, wherein like numerals refer to the same or similar features in the various figures, FIG. 1 is a block diagram of an example website prototyping system 100, in accordance with one or more embodiments. Not all of the depicted components may be used in all embodiments, and one or more embodiments may include additional, fewer, or different components than those shown in the figure. Variations in the arrangement and type of components may be made without departing from the spirit or scope of the claims as set forth herein. Furthermore, the modules described with respect to the system 100 are used for convenience to refer to functionality that the system 100 is configured to perform by way of one or more components of the system 100 (e.g., computer-readable instructions in memory).

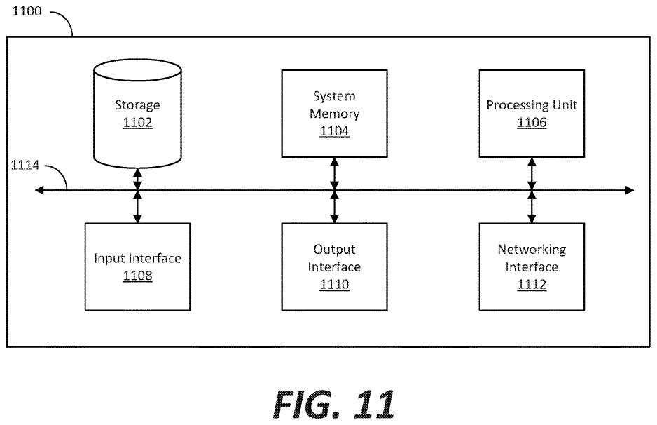

The system 100 may include a user device 102 associated with a user. The user device 102 may be a computing device such as a laptop computer, desktop computer, tablet, smartphone, smartwatch, or any other electronic device, such as a device having some or all of the components described with respect to FIG. 11. The user device 102 includes a user interface module 112. The user interface module 112 may include input devices, such as a keyboard and mouse, for receiving user input, and output devices, such as a display and speakers, for providing websites to the user. The user device 102 may be in electronic communication with a prototyping server 104 via a network 108.

The prototyping server 104 may be an electronic device that includes components described below with respect to FIG. 11 and may be in electronic communication with the model server 106 via the network 108. The prototyping server 104 may include a website template module 120 and a prompt template module 122.

The website template module 120 may store and retrieve or otherwise access website templates, each of which may be tailored to demonstrate one or more features. The website templates may be tagged or indexed by metadata corresponding to supported features, expected use cases, visual styles, and/or the like. When a developer selects a feature to prototype, the module 120 may retrieve the corresponding website templates. Prototyped features may include interactive item carousels, user authentication flows, real-time chat widgets, embedded scheduling tools, payment form integrations, or personalized content recommendation tools.

In some embodiments, the module 120 may dynamically assemble templates from modular templates components based on the specified feature requirements, rather than retrieving static full-page designs. For example, suppose a user selects a feature to prototype an online appointment booking system for a health clinic. Rather than retrieving a full static page pre-configured for the precise use case, the module 120 may analyze the feature requirements and construct the template by combining modular components drawn from a component library. The module 120 may select and combine a header component with a placeholder for a business logo and navigation links; a hero section component tailored to display a service-focused headline and a call-to-action button like “Book an Appointment”; a feature integration component with a remote scheduling platform, such as an embeddable calendar widget with availability slots and a submission form; a testimonials component for displaying patient reviews; and a footer component with business contact details and quick links. Each of these components may be stored independently and tagged with metadata describing its structure, layout characteristics, and/or the types of features it supports. The template module 120 may select components whose metadata matches the feature and context, like appointment booking for healthcare, and assemble them into a website template. The final assembled template may then be used to perform the operations described herein, resulting in a custom prototype website without requiring a predefined full-page design for every possible use case.

The module 120 may also parse the website template for content placeholders and replace the content placeholders with content generated by the prototyping server 104 and/or the model server 106.

The prompt template module 122 may facilitate automated content generation by storing and retrieving prompt templates used to generate prompts for AI-based generative models. The prompt templates may include predefined structured inputs to elicit specific types of output from a content generation model, such as item descriptions, UI text, or images aligned with the website's theme. When the user inputs contextual parameters, such as entity type or design tone, the prompt template module 122 may replace placeholders in the prompt template with contextual parameters and send the prompt to the corresponding generative model. For instance, a prompt template may contain placeholders like [ENTITY_TYPE] and [VISUAL_TONE], which the prompt template module 122 may replace with user input to generate content consistent with the expected context.

The model server 106 may be an electronic device that includes components described with respect to FIG. 11. The model server 106 may be a first-party deployment, operated by the same entity as the prototyping server 104, or a third-party deployment, operated by a different entity than the prototyping server 104. The model server 106 infrastructure may be remote, on-premises, and/or cloud-based.

In a first-party remote configuration, the model server 106 may be operated by the same entity that operates the prototyping server 104 but is hosted on external infrastructure, such as a private cloud or dedicated remote servers. This configuration enables centralized control over the model lifecycle, including custom training, prompt tuning, and usage monitoring, while utilizing scalable compute resources located off-site.

In a first-party on-premises (on-prem) configuration, the model server 106 may be deployed within the entity's local infrastructure. This configuration enables stronger control over data governance and lower latency processing. On-prem model servers 106 may leverage dedicated AI accelerators (e.g., graphics processing units (GPUs)) and support offline or semi-connected operations.

In a third-party configuration, the model server 106 may be operated by an external provider and accessed via a public or authenticated API. In this configuration, the prototyping server 104 may package prompts, send them to the model server 106 via API calls, and receive model-generated content in response. This configuration may reduce operational overhead and enable access to state-of-the-art models.

Hybrid configurations are also contemplated. In a hybrid configuration, the model server 106 may default to, e.g., a third-party model server for general-purpose content generation but fall back to a local first-party server for latency-sensitive tasks or domain-specific models. The prototyping server 104 may manage model selection logic, prompt routing, and/or output handling in a way that abstracts the underlying model infrastructure while maintaining consistency and performance.

The model server 106 may host (or may be in network communication with another server that hosts) one or more machine learning models. These machine learning models may include text generation models 130, such as large language models (LLMs), small language models (SLMs), fine-tuned models, domain-specific generative models, and/or any other type of model capable of producing natural language content based on structured prompts. The model server 106 may also include image generation models 132, such as diffusion-based models, transformer-guided generative models, and/or any other type of model capable of generating synthetic images or videos (collectively referred to as “images”) based on structured prompts. The models may be invoked using structured prompts formulated by the prompt template module 122 and may return content that the website template module 120 may use to populate the prototype website.

In some embodiments, the prototyping server 104 and/or the model server 106 are one or more servers, such as in a cloud environment. In some embodiments, the prototyping server 104 and the model server 106 may be virtual servers on the same computing device. In some embodiments, the prototyping server 104 and the model server 106 may be the same computing device. In some embodiments, the prototyping server 104 may be a first-party remote server and the model server 106 may be a third-party platform on one or more cloud servers accessed by the prototyping server 104 via an authenticated API.

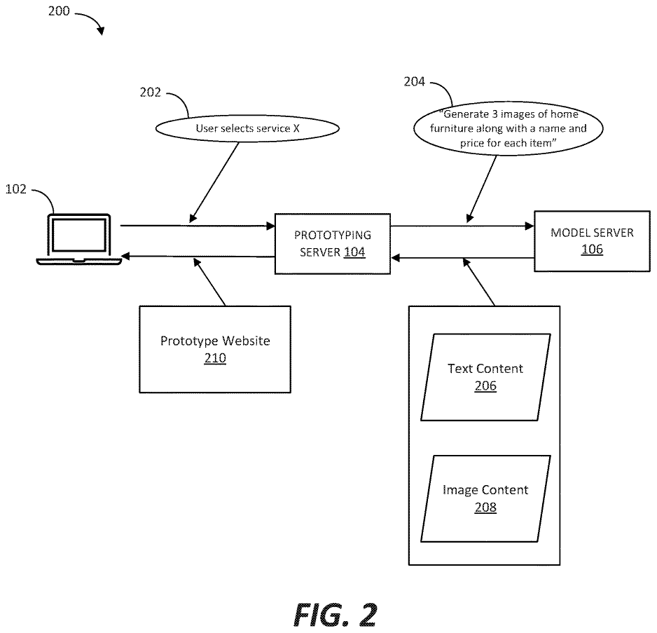

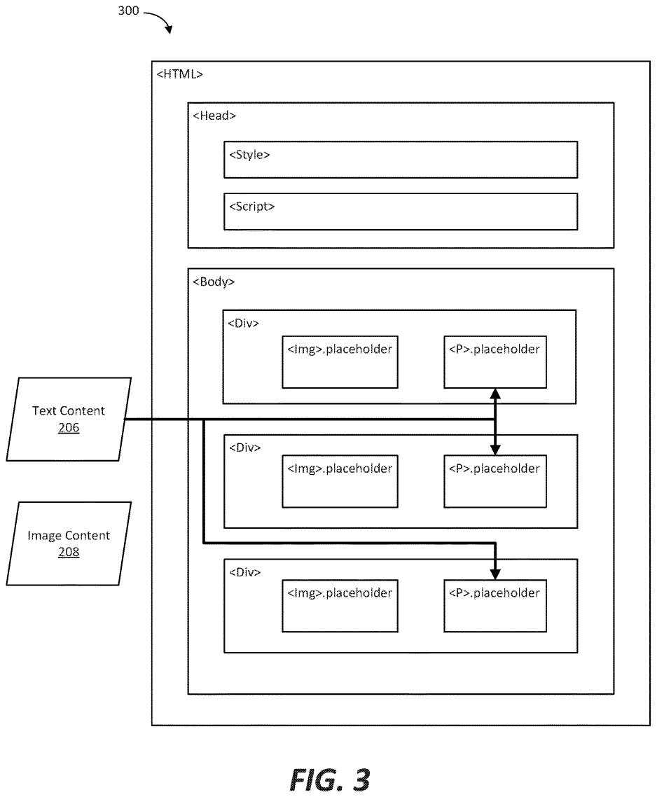

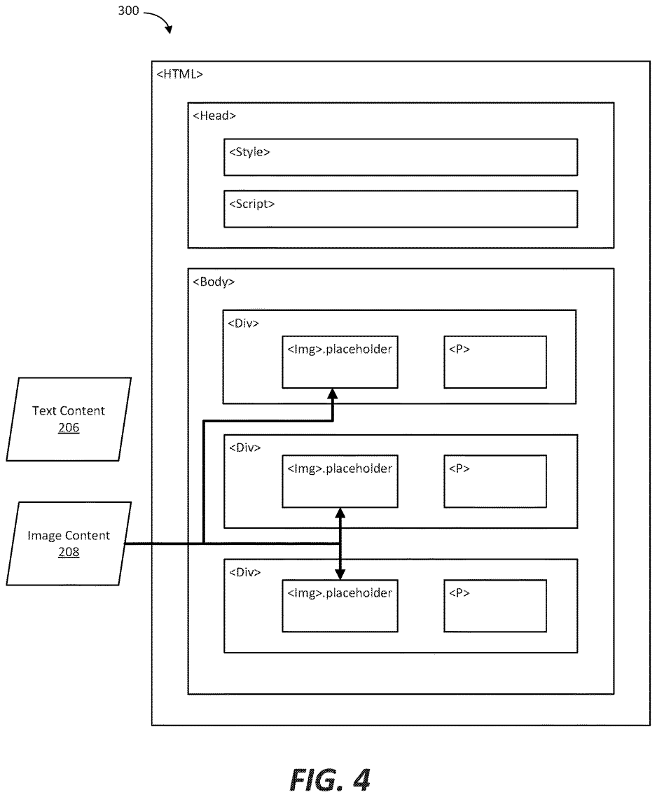

FIG. 2 is a block diagram of an example process 200 performed by the example system 100, in accordance with one or more embodiments. The user interacts with the system 100 via the user device 102 by specifying a feature (e.g., a third-party service integration) that they wish to demonstrate and providing contextual parameters such as items to showcase or color scheme. The user device 102 sends the specified feature (202) to the prototyping server 104, and the prototyping server 104 receives the specified feature, where the website template module 120 selects an appropriate website template (described in further detail below with respect to FIG. 3) and the prompt template module 122 generates structured prompts based on the user's inputs, such as “generate 3 images of home furniture along with a name and price for each item” (described in further detail below with respect to FIG. 4).

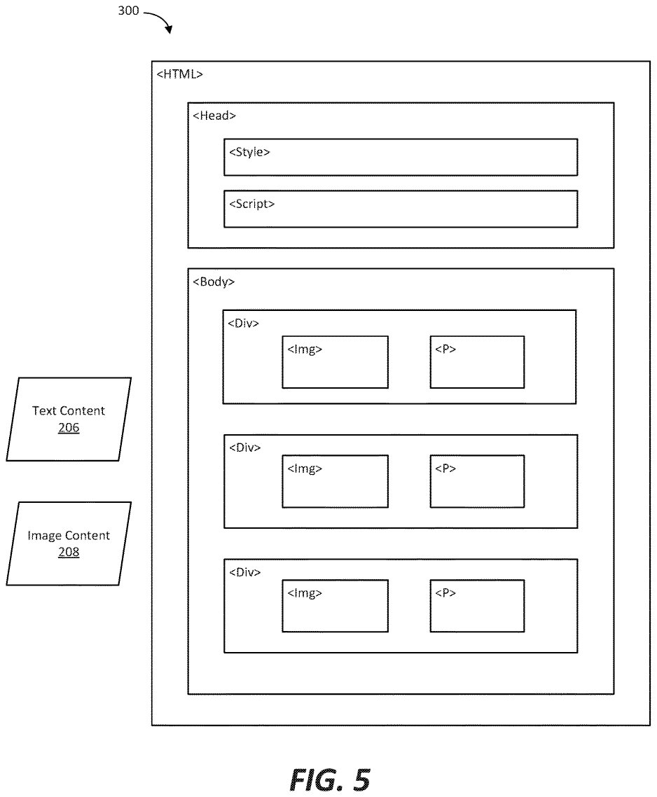

The prototyping server 104 sends the prompts (204) to the model server 106, which hosts machine learning models for text and/or image generation and may provide endpoints to the models (e.g., an API for each model) to input the prompts to the models regardless of where the models are deployed. In response, the relevant models generate synthetic content that the prototyping server 104 receives from the models and uses to populate the selected website template (described in further detail below with respect to FIG. 5). The synthetic content may include text content 206 (e.g., the name and price for each furniture item) and/or image content 208 (e.g., the images of each furniture item).

The prototyping server 104 populates the website template by identifying placeholders in the website template and replacing them with at least some of the text content 206 and/or the image content 208 as indicated by the placeholder. Once the prototyping server 104 has populated the website template, the prototyping server 104 may provide the resulting prototype website 210 to the user device 102, where the user can view the demonstration, inspect code snippets, or download the website files for self-hosting or further customization.

FIG. 3 is a block diagram of an example website template 300 with text content 206 replacement, in accordance with one or more embodiments. After the user device 102 sends the specified feature (202) to the prototyping server, the website template module 120 selects the website template 300. The website template 300 may be an HTML-based code template and may be pre-configured to have a particular feature integrated therein. The prototyping server 104 may scan the HTML structure of the template 300 for designated text placeholders. The placeholders may be marked by specific attributes or class names, such as a <p> element (which is for text) with a class like “placeholder”, which serve as semantic cues that the element or the content within is expected to be replaced.

Upon detecting the placeholders, the prototyping server 104 may initiate a content generation process. The content generation process may involve prompting a text generation model 130 (e.g., through an API call to the model server 106) to generate synthetic text content 206 that aligns with the user's contextual parameters, such as topic or tone. Prompting a text generation model 130 involves providing it with an input string (i.e., a prompt) that establishes the context, intent, and/or constraints for the desired output. The text generation model 130 processes the prompt using learned patterns from its training data and generates synthetic text content by predicting the most likely sequence of words that follow, conditioned on the prompt. This process may be autoregressive, with each generated token influencing the next until a stopping condition is met.

Once the text content 206 is available, the prototyping server 104 may generate a new HTML element. For example, the prototyping server 104 may take an existing <p class=“placeholder” [Placeholder]</p> and replace it with <p>Welcome to our furniture showcase! </p>, where the text is AI-generated text content 206 relevant to the demonstration's context.

In some embodiments, to enable consistent and reusable content replacement, placeholders in an HTML-based template 300 may include embedded semantic identifiers that describe the type and/or intent of its expected content. These embedded semantic identifiers enable the prototyping server 104 to recognize and match multiple placeholders that are meant to receive the same synthetic text content 206 across different sections of the template 300 and/or across templates.

One approach may use data attributes (e.g., data-* HTML attributes) or class names that encode the content role. For instance, rather than a paragraph element being marked with a generic class like “placeholder”, a more specific version might be: <p class=“placeholder” data-placeholder-key=“company_tagline”></p>

In this example, the attribute data-placeholder-key=“company_tagline” explicitly signals that this element is a placeholder and is expected to hold the company tagline. When the text content 206 includes a tagline (e.g., such as “Innovating furniture for the home”), the prototyping server 104 can identify all elements in the template 300 with the same data placeholder key and insert the same AI-generated text into each one. This enables consistency across multiple instances and reduces unnecessary duplication in content generation.

In some embodiments, the template 300 may include hierarchical or namespaced structure in the data placeholder keys, such as:
<h1 class=“placeholder” data-placeholder-key=“hero. title” </h1>
<p class=“placeholder” data-placeholder-key=“hero. subtitle” </p>
<p class=“placeholder” data-placeholder-key=“about. description”></p>

The prototyping server 104 may search for data placeholder keys like “hero. title” or “about. description”, which may indicate the website section (e.g., hero and about) and the content function (e.g., title and description) and enable the prototyping server 104 to place text content 206 more accurately. The prototyping server 104 may also utilize data placeholder keys as lookup references for text content 206 in a dictionary format, allowing for efficient and consistent population of the template 300 across each relevant placeholder. The data placeholder keys enables the prototyping server 104 to reuse content and enables more maintainable templates and scalable content management within prototyping server 104. For example, the text content 206 may include multiple strings in the following JSON format:
{
   “hero. title”: “Welcome to our furniture showcase!”,
   “hero.subtitle”: “Innovating furniture for the home”,
“about. description”: “We started our furniture company in 2000 to design furniture that . . . ”
}

FIG. 4 is a block diagram of the example website template 300 with image content replacement, in accordance with one or more embodiments. Like with text content 206, the prototyping server 104 may scan the HTML structure of the template 300 for designated image placeholders. The placeholders may be marked by specific attributes or class names, such as an <img> element with a class like “placeholder” which serve as semantic cues that the element or the content within is expected to be replaced.

In response to detecting such placeholder elements, the prototyping server 104 may initiate a content generation process. The content generation process may involve prompting an image generation model 132 (e.g., through an API call to the model server 106) to retrieve synthetic image content 208 that aligns with the user's input contextual parameters, such as topic or aesthetic. Prompting an image generation model 132 involves supplying a textual or structured description (i.e., a prompt) that specifies the desired visual content, such as scene elements, styles, and/or objects. The image generation model 132 interprets the prompt using its learned associations between language and visual features, and generates synthetic image content through iterative refinement, such as denoising steps in diffusion models or latent space decoding in transformer-based models.

Once the image content 208 is available, the prototyping server 104 may generate a new HTML element for the image content 208. For example, the prototyping server 104 may take an existing <img class=“placeholder” </img> and replace it with an <img> tag including a “src” attribute set to the file path of an image, where the image is AI-generated image content 208 relevant to the website's context, stored on the prototyping server 104, and locatable by its file path. The image may then be inserted into the webpage based on the “src” location when the HTML code is executed.

In some embodiments, to enable consistent and reusable content replacement, placeholders in an HTML-based template 300 may include embedded semantic identifiers that describe the type and/or intent of its expected content. These embedded semantic identifiers enable the prototyping server 104 to recognize and match multiple placeholders that are meant to receive the same synthetic image content 208 across different sections or pages of the template 300.

One approach may use data attributes (e.g., data-* HTML attributes) or class names that encode the content role. For instance, rather than marking an image element with a generic class like “placeholder”, a more specific version might be:
<img class=“placeholder” data-placeholder-key=“company_logo”></img>

In this example, the attribute data-placeholder-key=“company_logo” explicitly signals that this placeholder is expected to hold the company logo. When the image content 208 includes a logo, the prototyping server 104 can identify all elements in the template 300 with the same data placeholder key and insert the same AI-generated image into each one. This enables consistency across multiple instances and reduces unnecessary duplication in content generation.

In some embodiments, the template 300 may include hierarchical or namespaced structure in the placeholder keys, such as:
<img class=“placeholder” data-placeholder-key=“header_company_logo” </img>
<img class=“placeholder” data-placeholder-key=“footer_company_logo” </img>
<img class=“placeholder” data-placeholder-key=“carousel”></img>

The prototyping server 104 may search for data placeholder keys like “header_company_logo” or “footer_company_logo”, which indicate the website section (e.g., header and footer) and the content function (e.g., logo) and enable the prototyping server 104 to place image content 208 more accurately. The prototyping server 104 may also utilize data placeholder keys as lookup references for image content 208 in a dictionary format, enabling efficient and consistent population of the template 300 across each relevant placeholder. The data placeholder keys enables the prototyping server 104 to reuse content and enables more maintainable templates and scalable content management within the prototyping server 104. For example, the image content 208 may include more than a single image but may include multiple images in the following JSON format:
{
   “header_company_logo”: “demo_website/images/header_logo.png”,
   “footer_company_logo”: “demo_website/images/footer_logo.png”,
   “carousel”: “demo_website/images/carousel. png”
}

FIG. 5 is a block diagram of the example website template of FIG. 3, in accordance with one or more embodiments. The prototyping server 104 scans the HTML structure of the template 300, replaces each placeholder in the template 300, and thus generates a website template 300 populated with customized data, which in the case of FIG. 5 is text content 206 and image content 208. The prototyping server 104 may host the populated template 300 for the user device 102 to view as a demo website 210 and for the user device 102 to interact with the integrated website feature that the template 300 demonstrates.

After replacing each placeholder, the template 300 may include the following text elements:
<h1 data-placeholder-key=“hero. title” Welcome to our furniture showcase! </h1>
<p data-placeholder-key=“hero. subtitle” Innovating furniture for the home </p>
<p data-placeholder-key=“about. description” We started our furniture company in 2000 to design furniture that . . . ”</p>

After replacing each placeholder, the template 300 may include the following image elements:
<img data-placeholder-key=“header_company_logo”
src=“demo_website/images/header_logo. png” </img>
<img data-placeholder-key=“footer_company_logo”
src=“demo_website/images/footer_logo. png” </img>
<img data-placeholder-key=“carousel” src=“demo_website/images/carousel. png”></img>

In some embodiments, the website template module 120 may make multiple replacements for a given placeholder based on the quantity of generated content that corresponds to the placeholder. For example, the image location in the image content 208 may reference a group (e.g., folder) of a plurality of images, and the website template module 120 may replace a placeholder with a plurality of tags, e.g., a respective <img> tag for each image in the group. So, the website template module 120 may replace <img class=“placeholder” data-placeholder-key=“carousel” </img>with the following if the image content 208 includes “carousel”: “demo_website/images/carousel_imgs”, representing a folder with three images:
<img data-placeholder-key=“carousel”
src=“demo_website/images/carousel_imgs/img1.png” </img>
<img data-placeholder-key=“carousel”
src=“demo_website/images/carousel_imgs/img2.png” </img>
<img data-placeholder-key=“carousel”
src=“demo_website/images/carousel_imgs/img3.png”></img>

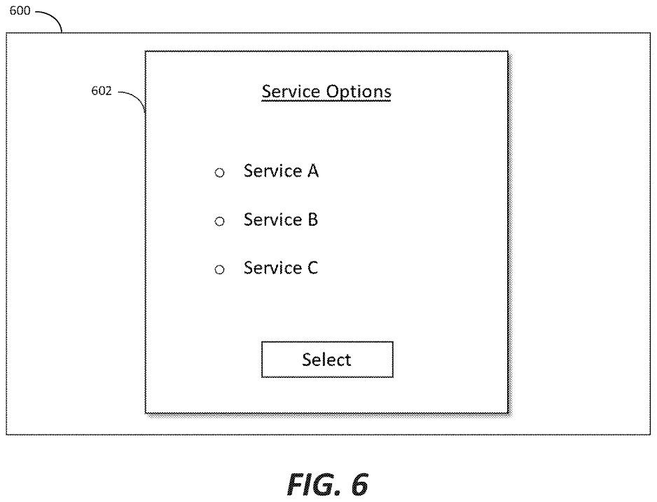

FIG. 6 is an example user interface for selecting a website template (e.g., website template 300), in accordance with one or more embodiments. From the user's perspective, the prototyping process may begin when they navigate to a prototyping portal 600, which may be hosted by the prototyping server 104. Accordingly, the prototyping server 104 may receive a request from a user device 102 to access the prototyping portal 600 and, in response, may serve the prototyping portal 600 for output on the user device 102. The prototyping server 104 may present to the user, in the prototyping portal 600, a list 602 of features available for prototyping. Each option in the list 602 may include a distinct feature (e.g., service, integration), such as an appointment booking tool, a product recommendation engine, a newsletter signup flow, or a third-party analytics dashboard, for example.

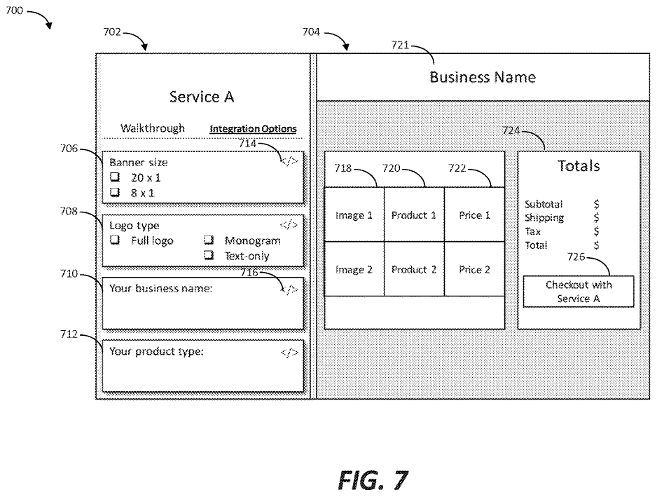

Each of the features listed in the prototyping portal 600 may be pre-integrated into one or more website templates. Each template may showcase one or more of the features that are available for selection by the user, with supporting visual structure, interaction flow, and content placeholders that make the feature stand out. The portal 600 may display these feature options as selectable buttons, each offering a title, description, and/or tags indicating the domain (e.g., e-commerce, healthcare, education) in which the service is most relevant. When the user selects a feature for prototyping, the prototyping server 104 may present, in response, a customization portion of the prototyping portal 600, which is described below with respect to FIGS. 7-9.

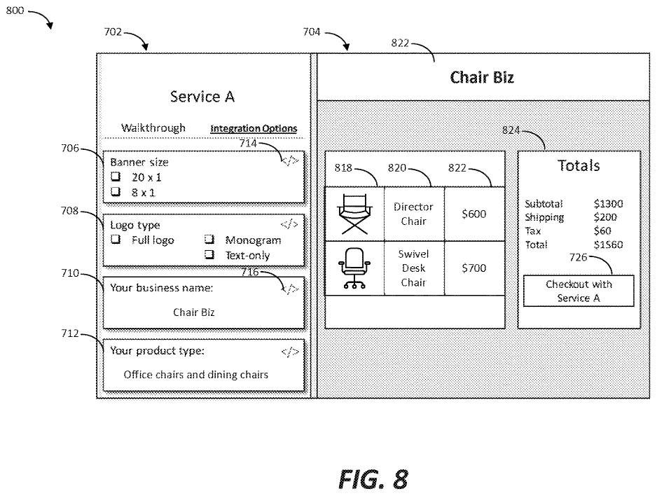

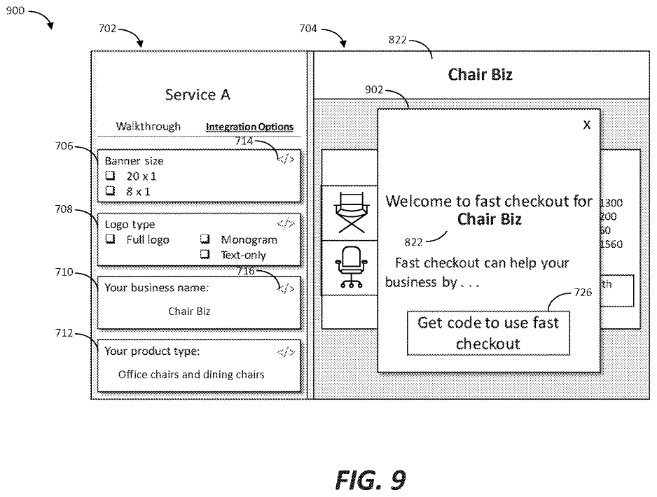

FIGS. 7-9 depict example states of a website template 704 that the prototyping server 104 may provide to the user in response to a user selection of a feature in the portal 600. FIG. 7 illustrates an initial state of the user interface 700 where the user can view the website template 704 with the placeholders. FIG. 8 illustrates a second state (designated user interface 800) where the user has input customizations that are reflected in the content populated in the website template 704. FIG. 9 illustrates a third state (designated user interface 900) in which the prototyping server 104 has output a multi-step feature portion of the website template in response to a user selection of an interface element.

FIG. 7 is an example user interface 700 for displaying a website template 704, in accordance with one or more embodiments. From this interface 700, the user device 102 may receive user inputs from the user exploring how the feature 726 behaves within the page, modifying content or settings interactively with form 702, viewing relevant code segments with buttons 714, 716, or requesting to download the generated website from the prototyping server 104 for further use. Providing the website template 704 on the user device 102 enables users to see demonstrations of the feature 726 in realistic, customized environments without needing to manually build a website from scratch.

The user interface 700 may include an interactive form 702 for the user to enter contextual parameters, such as company name, industry, target audience, visual theme, and/or any other preferences. Contextual parameters include inputs provided through the interactive form 702 that guide how the selected template 704 is customized with model-generated content. These parameters provide semantic context for prompt construction and help the generative models produce content that aligns with the intended tone, domain, and/or audience of the prototype. For example, a user may specify the company type as “organic skincare brand,” prompting the model to generate product descriptions and taglines with natural, wellness-focused language. Additionally or alternatively, a user could select and/or describe a visual theme like “modern minimalism,” leading the model(s) to generate text and/or imagery that reflect clean, understated aesthetics. Contextual parameters may be obtained through form fields that are open-ended and/or include predetermined options from which the user may select.

The form 702 may include fields with predetermined options, such as the banner size field 706 and the logo type field 708, which may cause the prototyping server 104 to automatically adjust certain parameters of the template, such as the banner size and the logo type.

The form 702 may also include open-ended fields, such as the company name field 710 and the item type field 712. The user may input values, such as text, into the open-ended fields, which may cause the website template module 120 to replace placeholders that correspond with the open-ended fields with the user-provided values. For example, the company name placeholders 721 may correspond to the company name field 710, and the prototyping server 104 may replace the company name placeholders 721 with the value provided in the company name field 710.

The prototyping server 104 may utilize the user-provided values in the open-ended fields to request AI-generated content from the model server 106. Once the user submits the form 702 (or field), the prototyping server 104 may obtain the associated prompt template for generating a prompt based on the one or more of the form fields. For example, if the company name field 710 and the item type field 712 have a value, the website template module 120 may obtain an item prompt template for prompting a text generation model 130 to generate the item names for placeholder 720 and corresponding item values for placeholder 722.

The prompt template may correspond to one or more fields in the form 702. The prompt template may include one or more prompt placeholders that the website template module 120 may replace with the value of the corresponding fields, such as the company name field 710 and/or the item type field 712. With the completed prompt template, the prototyping server 104 may prompt the text generation model 130 to generate the items for placeholder 720 and corresponding item values for placeholder 722.

In some embodiments, prompt templates may also include placeholders for content output from previous rounds of content generation. This way, for example, the item images generated by the image generation model 132 may be based on a prompt including the item names previously generated by the text generation model 130.

The prompt templates may also be associated with placeholders in the website template so that the prototyping server 104 may replace the appropriate website template placeholders with the AI-generated content. For example, the item listing prompt template may be named after the corresponding placeholder in the website template 704 so that the prototyping server 104 can replace placeholders 720, 722 with the content generated based on the item listing prompt template. This way, the prototyping server 104 may replace placeholders 720 with the AI-generated item names and placeholders 722 with the corresponding item values.

FIG. 8 is an example user interface 800 for displaying a first populated website template, in accordance with one or more embodiments. The interface 800 may be a version of the interface 700 in which the placeholders of the template 704 are replaced with content generated by the prototyping server 104 and/or the model server 106. Like the interface 700, the interface 800 includes the form 702 but with values input by the user into fields such as fields 710, 712.

The prototyping server 104 may use values in the form fields to replace placeholders in the website template 704. As mentioned above, a prompt template may include one or more placeholders that the prototyping server 104 may replace with the value of the corresponding fields, such as the company name field 710 and/or the item type field 712. For example, an item listing prompt template corresponding to the company name field 710 and the item type field 712 may include “Generate a list of 2 item listings, each item listing including an item name and corresponding retail values, for {COMPANY_NAME}'s new line of {ITEM_TYPE} products, considering factors such as market trends and customer appeal.”, where {COMPANY_NAME} may be the placeholder to be replaced with the value of the company name field 710 and {ITEM_TYPE} may be the placeholder to be replaced with the value of the item type field 712. With the completed item listing prompt template, the prototyping server 104 may prompt the text generation model 130 to generate the item names 820 and corresponding item values 822 for placeholders 720, 722, respectively. The prototyping server 104 may replace the placeholders 720, 722 with the item names 820 and corresponding item values 822 in a manner described above with respect to FIG. 3.

The prompt placeholders in the prompt templates enable the prototyping server 104 to reuse values in the form fields across prompt templates so that multiple rounds of content generation can be performed based on a single set of user input. For example, the prototyping server 104 may prompt an image generation model 132 in addition to the text generation model 130. The prototyping server 104 may apply an item image prompt template corresponding to the company name field 710 and the item type field 712 that includes “Generate 2 thumbnail photos showcasing {COMPANY_NAME}'s new line of {ITEM_TYPE} products, considering the product names: {ITEM_NAMES}”, where {COMPANY_NAME} may be the placeholder that the prototyping server 104 replaces with the value of the company name field 710, {ITEM_TYPE} may be the placeholder that the prototyping server 104 replaces with the value of the item type field 712, and {ITEM_NAMES} may be the placeholder that the prototyping server 104 replaces with the previously generated item names 820. With the completed item image prompt template, the prototyping server 104 may prompt the image generation model 132 to generate the item images 818 for image placeholders 718. The prototyping server 104 may replace the image placeholders 718 with the item images 818 in a manner described above with respect to FIG. 4.

The prototyping server 104 may also generate values for the website template 704 based on the AI-generated content. In this example, the prototyping server 104 may use the AI-generated item values 822 to generate item totals 824 for placeholder 724. For example, the prototyping server 104 may calculate the sum of the item values 822 to generate a subtotal value of the item totals 824 for placeholder 724.

With the website template 704 integrated with a feature 726 and populated with customizable content generated by the prototyping server 104 and/or the model server 106, the prototyping server 104 may provide a downloadable version of the website template 704 (e.g., HTML files and corresponding packages) to the user device 102 for the user to learn how the feature 726 is integrated and operates within the website environment. After a download, the user can modify the website template 704 and self-host it as necessary to utilize as a functional prototype.

The prototyping server 104 may also output particular code segments of the website template 704 to the user device 102 for the user to view those code segments. The prototyping server 104 may output code snippet fields in the buttons 714, 716 in the form 702 so that the user can view the code corresponding to those fields. The prototyping server 104 may display code segments corresponding to portions of the website template 704 with content generated by the prototyping server 104. For example, field 706 includes predetermined options that, when selected, cause the prototyping server 104 to modify corresponding portions of the website template 704 according to the predetermined options, and button 714 may allow the user to see the corresponding portions of the website template 704 that the prototyping server 104 modified with predetermined content. Similarly, the prototyping server 104 may display code segments corresponding to portions of the website template 704 with content generated by the model server 106. For example, field 710 includes open-ended options that, when provided a value, cause the prototyping server 104 prompt the model server 106 for AI-generated content, which the prototyping server 104 may use to modify corresponding portions of the website template 704 with the AI-generated content. The button 714 corresponding to field 710 may allow the user to see the corresponding portions of the website template 704 that the prototyping server 104 modified with AI-generated content.

FIG. 9 is an example user interface 900 for displaying a second populated website template 902, in accordance with one or more embodiments. In some embodiments, the website template 704 may include a feature 726 that includes multiple pages, each representing different stages of a single workflow, that the prototyping server 104 may output in response to user input in the template. For example, a checkout workflow may include a cart page and a confirmation page following the cart page. This allows the user to experience how an integrated feature behaves within a single page but also within the broader experience of a website as a whole.

Like the template 704, the template 902 may also be HTML-based and include one or more placeholders that may be replaced with values provided by the user in the corresponding fields in the form 702. Similarly, the template 902 may also include one or more placeholders (e.g., data-* attributes) that may be populated with AI-generated content, such as in a manner described above with respect to FIGS. 3-5. This way, a single change in the form 702 can be reflected throughout multiple pages of a website.

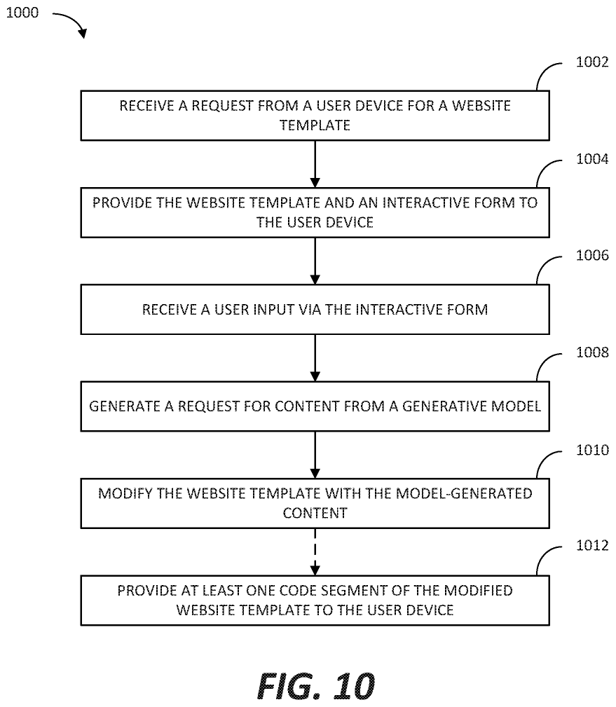

FIG. 10 is a flow diagram of an example automated website generation process 1000 that may be performed by the prototyping server 104, in accordance with one or more embodiments. For explanatory purposes, the figure is described with reference to the system 100 of FIG. 1 and thus the process 1000 may be a computer-implemented method. However, this is merely illustrative, and features of the system 100 may be performed by any other system for implementing the subject technology. Additionally, for explanatory purposes, the operations of the process 1000 are described herein as occurring sequentially or linearly. However, multiple operations of the process 1000 may occur in parallel. The operations of the process 1000 need not be performed in the order shown, and one or more operations of the process 1000 need not be performed or can be replaced by other operations.

At operation 1002, the prototyping server 104 receives a request from a user device for a website template and, in response, obtains a website template (e.g., template 300). Upon receiving user input, such as the selection of a service to prototype (e.g., shown in FIG. 6), the website template module 120 queries its repository of pre-defined templates, each of which may be indexed by metadata reflecting the feature and/or contexts they are configured to support. The module 120 may select the most appropriate template or set of templates that align with the feature selected by the user, where the feature may be a library, service, integration, or other software feature integrated with the website template.

Each selected website template may include a combination of static layout code and dynamic content placeholders. These templates may be written in HTML, JavaScript, and/or other programming languages and may be organized as complete pages or modular components. Within the template, one or more portions of the code may be indicated as code segments where dynamic content is expected to be inserted. For example, these code segments may span a range of HTML elements, such as <p>, <h1>, <img>, or <div>, each acting as a shell for synthetic content generation.

Each code segment may include one or more content placeholders. A content placeholder may include, for example, an identifying attribute such as a data placeholder key, a class name that allows the server 104 to detect it during template parsing, and/or other information types that may designate a placeholder. The server 104 may recognize a content placeholder, determine a predefined content type associated with the content placeholder, and process the placeholder according to the associated content type. Content types may include textual categories like “tagline,” “item description,” or “feature explanation,” as well as image categories such as “hero image,” “icon set,” or “testimonial photo.”

The website template module 120 may maintain a structured representation of the template that includes a mapping between data placeholder keys and their respective corresponding content types. The prompt template module 122 may use the mapping to determine what kind of data is needed for each placeholder key and how to generate the needed data. The mapping may also allow for placeholder consistency across the template so that the same generated content can be placed into multiple code segments where the data placeholder keys match.

In some embodiments, a website template may include both placeholders for dynamically generated synthetic content and also placeholders for dynamically generated code. In this scenario, a website template may include a code segment that includes a placeholder for another code segment, such as a reusable component, interactive feature, or service integration code snippet. For example, within the main HTML structure, a <div> element might include a placeholder like data-placeholder-key=“component.featureWidget”, which the prototyping server 104 uses to determine that this segment should be populated with a dynamically assembled code. When the prototyping server 104 encounters this code placeholder, the server 104 may initiate a secondary templating process. Based on the feature selected by the user (e.g., a pricing calculator, a chat widget, or an appointment scheduler), for example, the server 104 may use the text generation model 130 to dynamically generate the code for the primary website template. The generated code may itself be structured with internal placeholders. For instance, a pricing calculator component may include nested placeholders for parameters such as currency, feature labels, and user instructions. The placeholders of the dynamically generated code, identified by their own data placeholder key attributes, may subsequently be populated with synthetic content in a manner similar to the primary website template.

At operation 1004, the prototyping server 104 provides the website template and an interactive form (e.g., form 702) to the user device for display to the user. The form enables the user to guide the generation of content for the template by providing input values to form fields. The form may include a structured set of input fields, where each field corresponds to a placeholder or other template configuration point (e.g., title or banner size). The fields may include text inputs for company names, dropdown menus for industry categories, sliders for tone or formality, color pickers for theme preferences, and/or other website customization options. The form may reflect the semantic structure of the content placeholders within the template, providing an interface for the user to influence customization of the website without needing to interact directly with the website template code.

For visual clarity and user experience, the prototyping server 104 causes the user device 102 to display the form and the live preview of the template in a two-panel layout. The first interface panel may present the form, allowing the user to input or modify the form field values. The second interface panel, positioned adjacent to the first, may render the website template either in its current state or in a real-time preview that reflects the form field values as they are input into the form.

It should be understood that the dual-panel interface is merely an example layout of the website and the form to the user, and other layouts are contemplated. In some embodiments, the template may be presented such that each customizable component is interactive, and interacting with a customizable component may cause the user device 102 to render a form and/or form field. For example, if the user clicks the “company name” placeholder in the header of the template, the user device 102 may render a company name field for the user to input a company name value.

At operation 1006, the prototyping server 104 receives from the user device 102 a second user input via the interactive form. When the user interacts with the interactive form rendered on the user device 102 (e.g., by entering a company name, selecting a theme, or specifying an item category), the form captures the user input and sends it to the prototyping server 104. Each input field in the form may be programmatically linked to a corresponding code segment within the website template. The linkage may be established using structured identifiers (e.g., “data-placeholder-key” attributes or field names) that map form fields to the content placeholders within the template.

In response to receiving the user input, the prototyping server 104 may parse the incoming data and associate each value with its target code segment. For example, if the user enters “Chair Biz” into a field labeled company_name, the prototyping server 104 may recognize that this value is expected to replace or influence a specific placeholder, such as an <h1> tag marked with “data-placeholder-key” set to “header. company_name”. The server 104 may determine an association based on a server-side map, such as a dictionary or metadata model that tracks which fields affect which parts of the template. The server 104 may update its internal representation of the website template to reflect the user's input.

At operation 1008, the prototyping server 104 generates a request for content from a generative model, such as by providing a prompt to a content generation model for generating website content. The content generation model may be local (on the prototyping server 104) and/or remote (on the model server 106). Each prompt template may be associated with a content type and include one or more parameter placeholders, which represent dynamic parts of the prompt template that can be substituted with user-provided values. The content type may indicate the type of content to be generated, such as text or images.

The prompt templates may be stored by the prompt template module 122 as structured text blocks or parameterized strings, which may use markers such as [brackets], {curly brackets}, or <angle brackets> to indicate placeholders for values. For example, a prompt template for generating a company tagline may be: “Generate a concise and compelling business tagline for a company named [COMPANY_NAME] that operates in the [INDUSTRY] sector.”

Once the prompt template module 122 has retrieved the relevant prompt template, the prompt template module 122 may perform placeholder substitution by replacing the placeholders with the corresponding user input captured from the form. Continuing the previous example, if the user provided “Chair Biz” as the company name and “furniture” as the industry, the resulting prompt might read: “Generate a concise and compelling business tagline for a company named Chair Biz that operates in the furniture sector.”

The prototyping server 104 may then send the prompt to the model server 106, where the prompt is used to query one or more generative models. For instance, if the prompt is associated with a text content type, the prompt may be provided to the text generation model 130, and if the prompt is also or instead associated with an image content type, the prompt may also or instead be provided to the image generation model 132. The model may process the prompt and output synthetic content, such as a text string.

At operation 1010, in response to the prompt, the prototyping server 104 receives the content generated by the content generation model and modifies the website template with the model-generated content. Once the prompt has been provided to the generative model and AI-generated content is received, the prototyping server 104 proceeds to the content integration phase. The content may already be contextualized by the parameters (e.g., field values) passed in the prompt and directly associated with the form fields used during prompt template selection. The website template module 120 may also maintain a mapping between form fields and their corresponding placeholders within the HTML-based template. Thus, the website template module 120 may identify code segments that contain a placeholder associated with the new AI-generated content. The placeholders may be identified by attributes, such as data-* attributes or class names, which allow the website template module 120 to precisely locate and target the relevant segments for replacement.

The website template module 120 may then perform a replacement of the identified content placeholders with the appropriate generated content. For instance, a code segment originally containing <h1 data-placeholder-key=“company_name” [Placeholder]</h1> may be transformed to <h1>Chair Biz</h1> when the generative model returned “Chair Biz” in response to a prompt for a company name. The replacement operation may be implemented through HTML parsing and manipulation libraries that preserve the integrity of the website template while enabling targeted updates to dynamic regions.

The prototyping server 104 may send the updated template, now containing contextualizing content instead of abstract placeholders, back to the user device 102. In systems designed for real-time interaction, the prototyping server 104 may send the updated template via asynchronous mechanisms, such as a WebSocket channel or a client-initiated polling response, enabling the updated template to be dynamically presented in the browser without requiring a full page reload.

In some embodiments, to support reuse of generated website content, the prototyping server 104 may include content caches that store generated content keyed based on form fields and/or form values. If the user later selects a different template to prototype another feature, for example, the prototyping server 104 may then consult the content cache before invoking the content generation model again. If a cached entry matches the form field and/or field value of a current website template, the prototyping server 104 may then directly retrieve and reuse the previously generated content to populate the relevant placeholders in the new template.

At operation 1012, the prototyping server 104 provides at least one code segment of the modified website template to the user device 102 in response to a request from the user device 102. This operation may be performed to support technical users (e.g., developers or designers) who may wish to extract, inspect, and/or repurpose portions of the generated prototype for further development or integration into their own systems. The request from the user device 102 may originate through an interactive control on the user interface, such as a button 716.

Upon receiving the request, the prototyping server 104 may access the modified template and identify the specific code segments associated with the request. These code segments may be extracted and/or formatted for providing to the user device 102. In some embodiments, the prototyping server 104 provides a downloadable set of files (e.g., .html, .css, or .js documents) including the relevant code segments. In some embodiments, the prototyping server 104 may provide the code segments as part of a dynamic user interface update. The code segments may be rendered in a dedicated interface panel or overlay along side the live website preview and customization form.

FIG. 11 is a block diagram of an example computing system 1100 with which aspects of the present disclosure may be implemented. The computing system 1100 may be, and/or may be part of, any electronic device for generating the features and processes described in reference to the foregoing figures, including but not limited to a desktop computer, server computer, tablet computer, smartphone, and wearable device (e.g., smartwatch, fitness band). The computing system 1100 may include various types of computer-readable media and interfaces for various other types of computer-readable media. The computing system 1100 includes a processing unit 1106, persistent storage device 1102, system memory 1104, input device interface 1108, output device interface 1110, bus 1114, and/or network interface 1112.

The bus 1114 collectively represents all system, peripheral, and chipset buses that communicatively connect the numerous internal components of the computing system 1100. In one or more embodiments, the bus 1114 communicatively couples the processing unit 1106 with the system memory 1104 and/or the persistent storage device 1102. From these various memory units, the processing unit 1106 retrieves instructions to execute and data to process in order to execute the processes of the subject disclosure. The processing unit 1106 can be one or more processors, each of which can be a single-or multi-core processor.

The persistent storage device 1102 may be a non-volatile memory unit that stores instructions and data. The persistent storage device 1102 may be or include a mass-storage device (e.g., a magnetic or optical disk and its corresponding disk drive). In some embodiments, a removable storage device (e.g., a floppy disk, flash drive, and its corresponding disk drive) may be used as the persistent storage device 1102.

The system memory 1104 may be a volatile read-and-write memory, such as RAM. The system memory 1104 may store any of the instructions and data that the processing unit 1106 may need at runtime. In some embodiments, the processes of the present disclosure are stored in the system memory 1104 and/or the persistent storage device 1102. From these various memory units, the processing unit 1106 retrieves instructions to execute and data to process in order to execute the processes of one or more implementations.

The bus 1114 also connects to the input device interface 1108 and output device interface 1110. The input device interface 1108 enables a user to communicate information and send commands to the computing system 1100. Input devices that may be used with the input device interface 1108 may include, for example, keyboards, touch screens, and pointing devices. The output device interface 1110 may enable, for example, the display of text and/or images generated by computing system 1100. Output devices that may be used with the output device interface 1110 may include, for example, printers and display devices, such as a liquid crystal display (LCD), a light emitting diode (LED) display, an organic light emitting diode (OLED) display, a flexible display, a flat panel display, a projector, or any other device for outputting information.

One or more embodiments may include devices that function as both input and output devices, such as a touchscreen. Feedback provided to the user can be any form of sensory feedback, such as visual feedback, auditory feedback, or tactile feedback. Input from the user may be received in any form, including acoustic, speech, or tactile input.

The bus 1114 also couples the computing system 1100 to one or more networks and/or to one or more network nodes through the network interface 1112. In this manner, the computing system 1100 can be a part of a network of computers (such as a local area network (LAN), a wide area network (WAN), or an intranet, or a network of networks, such as the internet). Any or all components of the computing system 1100 can be used in conjunction with the present disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be a non-transitory computer-readable medium.

The computer-readable storage medium can be any storage medium that can be read, written, or otherwise accessed by a general purpose or special purpose computing system, including any processing electronics and/or processing circuitry capable of executing instructions. For example, without limitation, the computer-readable medium can include any volatile semiconductor memory, such as RAM (Random Access Memory), DRAM (Dynamic RAM), SRAM (Static RAM), and Z-RAM (Zero-Capacitor RAM). The computer-readable medium also can include any non-volatile semiconductor memory, such as ROM (Read-Only Memory), PROM (Programmable ROM), EPROM (Erasable Programmable ROM), EEPROM (Electrically Erasable Programmable ROM), NVRAM (Non-Volatile RAM), and flash memory.

Further, the computer-readable storage medium can include any non-semiconductor memory, such as optical disk storage, magnetic disk storage, magnetic tape, other magnetic storage devices, or any other medium capable of storing machine-readable instructions. In one or more implementations, the tangible computer-readable storage medium can be directly coupled to a computing system, while in other implementations, the tangible computer-readable storage medium can be indirectly coupled to a computing system, e.g., via one or more wired and/or wireless connections.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled persons may implement the described functionality in varying ways for each particular application. Various components and blocks may be arranged differently (e.g., arranged in a different order, or partitioned in a different way) all without departing from the scope of the present disclosure.

While this disclosure has described certain embodiments, it is understood that the claims are not intended to be limited to these embodiments except as explicitly recited in the claims. On the contrary, the instant disclosure is intended to cover alternatives, modifications, and equivalents, which may be included within the spirit and scope of the disclosure. Furthermore, in the detailed description of the present disclosure, numerous specific details are set forth in order to provide a thorough understanding of the disclosed embodiments. However, the present disclosure is not limited to the specific details set forth herein and can be practiced using one or more other embodiments. In other instances, well known methods, procedures, components, and circuits have not been described in detail as not to unnecessarily obscure various aspects of the present disclosure. Additionally, in one or more embodiments, structures and components are shown in block diagram form to avoid obscuring the concepts of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing system. For reasons of convenience, and with reference to common usage, such data is referred to as bits, values, elements, symbols, characters, terms, numbers, or the like, with reference to various presently disclosed embodiments. It is understood, however, that these terms are to be interpreted as referencing physical manipulations and quantities and are merely convenient labels that should be interpreted further in view of terms commonly used in the art.

Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing system, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of any of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the subject disclosure.

What is claimed is:

1. A method comprising:
obtaining a website template corresponding to a first user input from a user device, wherein the website template includes at least one code segment, each code segment includes a content placeholder, and each content placeholder is associated with a content type for dynamically generated content;
providing the website template and an interactive form to the user device for display on the user device;
receiving, from the user device, a second user input via the interactive form, wherein the second user input is associated with a code segment of the website template;
providing a prompt to a generative model for generating website content, wherein the prompt is based on the second user input and the content type associated with the code segment;
receiving the website content generated by the generative model in response to the prompt, wherein the website content is associated with the content type;
replacing the content placeholder of the code segment with the website content to form a modified website template; and
providing the modified website template to the user device for display on the user device.

2. The method of claim 1, wherein receiving the website content comprises storing the website content in association with the website template.

3. The method of claim 2, wherein the website template is a first website template, the method further comprising:
obtaining a second website template corresponding to the first website template, wherein the second website template includes the code segment;
replacing the content placeholder of the code segment with the website content to form a modified second website template; and
providing the modified second website template to the user device for display on the user device.

4. The method of claim 3, wherein obtaining the second website template is responsive to receiving a third user input via the modified website template.

5. The method of claim 1, wherein providing the prompt comprises:
generating the prompt based on a predefined prompt template associated with the content type.

6. The method of claim 5, wherein the prompt template includes a parameter placeholder and generating the prompt comprises:
replacing the parameter placeholder with a value based on the second user input.

7. The method of claim 1, further comprising:
causing the interactive form to be displayed in a first panel; and
causing the website template to be displayed in a second panel adjacent to the first panel;
wherein receiving the second user input via the interactive form in the first panel causes the website template to be dynamically modified in the second panel.

8. The method of claim 7, further comprising providing the at least one code segment to the user device to be displayed in a third panel.

9. The method of claim 8, wherein the third panel is displayed in response to a fourth user input to a visual element of the interactive form.

10. The method of claim 1, further comprising:
generating a set of files based on the modified website template; and
providing the set of files to the user device for self-hosting.

11. A computing device comprising:
a processor; and
a non-transitory computer-readable medium storing instructions that, when executed by the processor, cause the computing device to perform operations comprising:
receiving a request for a code template based on a first user input from a user device, wherein the code template comprises a placeholder for dynamically generated content, and the placeholder is associated with a content type;
transmitting an interactive form to the user device, wherein the interactive form comprises a field for a second user input corresponding to the placeholder;
in response to receiving the second user input via the field of the interactive form, generating and providing a prompt to a generative model to generate content, wherein the prompt is based on the second user input and the content type associated with the placeholder;
receiving content generated by the generative model in response to the prompt and storing the content in association with the code template; and
dynamically modifying the code template by replacing the placeholder with the content and causing the user device to render the modified code template.

12. The computing device of claim 11, wherein the code template is a first code template and the request is a first request, the operations further comprising:
receiving a second request for a second code template selected based on a third user input, wherein the second code template comprises a second placeholder for dynamically generated content; and
dynamically modifying the second code template by replacing the second placeholder in the second code template with the stored content and causing the user device to render the modified second code template.

13. The computing device of claim 12, wherein receiving the second request for the second code template is responsive to receiving the third user input via a visual element of the modified code template.

14. The computing device of claim 11, wherein:
the prompt is generated according to a first prompt template in response to the content type being a first content type; and
the prompt is generated according to a second prompt template in response to the content type being a second content type.

15. The computing device of claim 14, wherein:
the generative model is a large language model in response to the content type being a first content type; and
the generative model is a diffusion-based model in response to the content type being a second content type.

16. The computing device of claim 11, wherein the placeholder for dynamically generated content is a first placeholder, and the code template further comprises a second placeholder for dynamically generated code.

17. The computing device of claim 16, further comprising:
in response to receiving the request for the code template, generating and transmitting a second prompt to a second generative model to generate code based on the second placeholder; and
dynamically modifying the code template by replacing the second placeholder with the code and causing the user device to render the modified code template.

18. A non-transitory computer-readable medium storing instructions that, when executed by a processor of a computing device, cause the computing device to perform operations comprising:
receiving a selection of a website template corresponding to a first user input, wherein the website template includes at least one code segment, each code segment includes a content placeholder, and each content placeholder is associated with a content type for dynamically generated content;
providing the website template and an interactive form to the user device for display on the user device;
receiving a second user input via the interactive form, wherein the second user input is associated with a code segment of the website template;
in response to the content type of the code segment corresponding to a first content type, providing a prompt to a first generative model for generating website content;
in response to the content type of the code segment corresponding to a second content type, providing the prompt to a second generative model for generating website content;
receiving the website content and replacing the placeholder of the code segment with the website content to form a modified website template; and
providing the modified website template to the user device for display on the user device.

19. The non-transitory computer-readable medium of claim 18, wherein the prompt is selected from a set of predefined prompt templates according to the content type, and the prompt include a parameter placeholder, and providing the prompt comprises replacing the parameter placeholder with a value based on the second user input.

20. The non-transitory computer-readable medium of claim 18, wherein the prompt is formed according to a first prompt template in response to the content type corresponding to the first content type, and the prompt is formed according to a second prompt template in response to the content type corresponding to the second content type.
